(19) United States
(12) Patent Application Publication
(10) Pub. No.: US 2019/0196528 A1
(43) Pub. Date: Jun. 27, 2019

(54) CURRENT-LIMITING CIRCUIT AND CONTROLLING METHOD THEREOF

(71) Applicant: PEGATRON CORPORATION, Taipei City (TW)

(72) Inventors: Chun-Hung WU, Taipei City (TW); Chau-Tung FAN CHIANG, Taipei City (TW)

(21) Appl. No.: 16/230,339

(22) Filed: Dec. 21, 2018

(30) Foreign Application Priority Data
Dec. 22, 2017 (TW) 106145346

(51) Int. Cl. G05F 3/16; H02H 9/02

(52) U.S. Cl. CPC G05F 3/16; H02H 9/025

(57) ABSTRACT

A current-limiting circuit and a controlling method thereof are disclosed. The current-limiting circuit includes a current input terminal, a current output terminal, a switch module, a differential amplifier, a first resistor and a first capacitor. A signal input end of the switch module is connected to the current input terminal, and a signal output end is connected to the current output terminal. A positive input end of the differential amplifier is connected to the signal output end of the switch module, a negative input end is connected to the current output terminal, and an amplified output end is connected to a control end of the switch module. The first resistor is connected to the signal output end, the positive input end, the negative input end, and the current output terminal. The first capacitor is connected to the first resistor, the current output terminal, and a ground.

### BACKGROUND

### 1. Technology Field

The present disclosure relates to a current-limiting circuit and a controlling method thereof, particularly to a current-limiting circuit capable of suppressing instantaneous large currents and a controlling method thereof.

### 2. Description of the Related Art

Under power line operations in the prior art, when the load terminal needs to consume a large current instantaneously, instability of the load voltage and the source voltage may result and the output noise becomes large, which seriously affects the overall performance of the system. For example, in the power supplied to the WIFI line, when the system sends a beacon detection signal in the idle state, the load will consume a large current instantaneously. At this time, the current will have a large dynamic load. As a result, the power supply design of the input must be large enough to start the over power protection (OPP), which causes unstable output voltage. High-power wireless transmission electronic products, such as wireless APs, radio transceivers and radios, are prone to such application conditions.

To solve the aforementioned problem in the prior art, a filter with a larger amount of inductance or a larger capacitance is usually used to filter and suppress instantaneous large currents, or an input power supply with a higher specification is used. As a result, the design cost and space will be increased, and it is not cost-effective.

Accordingly, it is necessary to devise a new current-limiting circuit and a controlling method thereof to solve the problem in the prior art.

### SUMMARY

It is a major objective of the present disclosure to provide a current-limiting circuit that provides the effect of suppressing instantaneous large currents.

It is another objective of the present disclosure to provide a controlling method used for the structure described above.

To achieve the above objectives, the current-limiting circuit of the present disclosure includes a current input terminal, a current output terminal, a switch module, a differential amplifier, a first resistor and a first capacitor. The switch module includes a signal input end, a signal output end and a control end. The signal input end is electrically connected to the current input terminal. The signal output end is electrically connected to the current output terminal. The differential amplifier includes a positive input end, a negative input end and an amplified output end, wherein the positive input end is electrically connected to the signal output end of the switch module, the negative input end is electrically connected to the current output terminal, and the amplified output end is electrically connected to the control end of the switch module. An end of the first resistor is electrically connected to the signal output end and the positive input end of the switch module, and the opposite end of the first resistor is electrically connected to the negative input end and the current output terminal. An end of the first capacitor is electrically connected between the first resistor and the current output terminal, and the opposite end of the first capacitor is connected to a ground.

A method of controlling the current limiting circuit of the present disclosure includes the following steps: inputting an initial current signal by a current input terminal to flow through two ends of the first resistor to generate a voltage difference; outputting a control signal by a differential amplifier according to the voltage difference; determining whether the voltage of the control signal is less than a cut-off voltage; when the voltage of the control signal is less than the cut-off voltage, keeping the switch module on to cause the current output terminal to output an initial current signal; charging the first capacitor by the initial current signal; when the voltage of the control signal is greater than the cut-off voltage, turning off the switch module so that the current output terminal does not output the initial current signal; and discharging from the first capacitor to output a discharge current signal through a current output terminal.

### BRIEF DESCRIPTION OF THE DRAWINGS

FIG. 1 is an architecture diagram of a current-limiting circuit of the present invention; and

FIG. 2 is a flowchart showing steps in a method for controlling the current limiting circuit of the present invention.

### DETAILED DESCRIPTION OF THE PREFERRED EMBODIMENT

Hereafter, the technical content of the present invention will be better understood with reference to preferred embodiments.

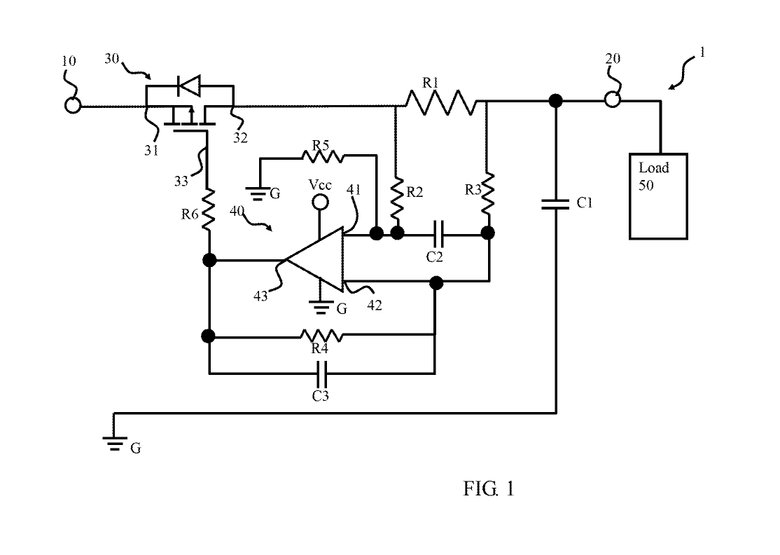

Hereafter, please first refer to FIG. 1, which is an architecture diagram of a current-limiting circuit of the present invention.

In the embodiment of the present invention, a current-limiting circuit 1 is used to ensure a stable power output. The current-limiting circuit 1 includes a current input terminal 10, a current output terminal 20, a switch module 30, a differential amplifier 40, a first resistor R1 and a first capacitor C1. The current input terminal 10 is used to input an initial current signal. The current output terminal 20 is used to output the current signal to a load 50. The switch module 30 has a signal input end 31, a signal output end 32 and a control end 33. In an embodiment of the present invention, the switch module 30 is a P-type metal-oxide-semiconductor field-effect transistor (MOSFET), but the present invention is not limited thereto. Thus, the source of the switch module 30 is the signal input end 31, the drain thereof is the signal output end 32, and the gate thereof is the control end 33. The signal input end 31 is electrically connected to the current input terminal 10, and the signal output end 32 is electrically connected to the current output terminal 20. The switch module 30 has a cut-off voltage. When the signal voltage inputted by the control end 33 exceeds the cut-off voltage, the MOSFET is activated to turn off the signal transmission between the signal input end 31 and the signal output end 32.

The differential amplifier 40 has a positive input end 41, a negative input end 42 and an amplified output end 43, wherein the positive input end 41 is electrically connected to the signal output end 32 of the switch module 30, the negative input end 42 is electrically connected to the current output terminal 20, and the amplified output end 43 is electrically connected to the control end 33 of the switch module 30. The differential amplifier 40 is a rail-to-rail amplifier, which is activated by receiving a power signal supplied by the power supply Vcc. Therefore, in the best case, the voltage of the power signal inputted by the power supply Vcc can be outputted through the amplified output end 43, so there is no need to supply additional power or other ICs with the switch module 30. An end of the first resistor R1 is electrically connected to the signal output end 32 and the positive input end 41 of the switch module 30, and the opposite end of the first resistor R1 is electrically connected to the negative input end 42 and the current output terminal 20; that is, the first resistor R1 is connected between the positive input end 41 and the negative input end 42. An end of the first capacitor C1 is electrically connected between the first resistor R1 and the current output terminal 20, and the opposite end of the first capacitor C1 is connected to a ground G. The first capacitor C1 may be 100 μF, and the first resistor R1 may be 10Ω, but the present invention is not limited thereto.

In addition to the above components, the positive input end 41 of the differential amplifier 40 is connected to the first resistor R1 via the second resistor R2, and the negative input end 42 is connected to the first resistor R1 via the third resistor R3. Also, the negative input end 42 is connected to the amplified output end 43 via the fourth resistor R4, and the positive input end 41 is connected to the ground G via the fifth resistor R5. In the embodiment of the present invention, the second resistor R2 and the third resistor R3 have the same resistance value, e.g., 1 kΩ, and the fourth resistor R4 and the fifth resistor R5 have the same resistance value, e.g., 91 kΩ. Therefore, the magnification of the differential amplifier 40 is equivalent to the second resistor R2 divided by the fourth resistor R4. Also, the current-limiting circuit 1 further includes a second capacitor C2, a third capacitor C3 and a sixth resistor R6, wherein the second capacitor C2 is connected in parallel with the first resistor R1, the third capacitor C3 is connected in parallel with the fourth resistor R4, and the sixth resistor R6 is connected in series between the differential amplifier 40 and the switch module 30. The second capacitor C2 and the third capacitor C3 may be 1000 pF, and the sixth resistor R6 may be 0.1Ω, but the present invention is not limited thereto. Since the other passive components in the current-limiting circuit 1 are not the focus of the improvement, they will not be described in detail herein.

After an initial current signal is inputted by the current input terminal 10 of the present invention, it will flow to the two ends of the first resistor R1 via the switch module 30, so the two ends of the first resistor R1 will have a voltage difference. The positive input end 41 and the negative input end 42 of the differential amplifier 40 are electrically connected to two ends of the first resistor R1. Therefore, the differential amplifier 40 outputs a control signal to the control end 33 of the switch module 30 via the amplified output end 43 according to the voltage difference. When the load 50 requires a small current, the current value of the initial current signal will be smaller, so the voltage of the control signal outputted from the amplified output terminal 43 will be less than the cut-off voltage of the switch module 30, and the switch module 30 will be kept ON. In this way, the current output terminal 20 continuously outputs the initial current signal to the load 50 and simultaneously charges the first capacitor C1. When the load 50 requires a large instantaneous current, the current value of the initial current signal increases beyond the current value that the original circuit can carry. At this time, the voltage difference of the two ends of the first resistor R1 is also increased, and the amplified output end 43 outputs a control signal with a larger voltage. When the voltage of the control signal outputted from the amplified output terminal 43 is greater than the cut-off voltage of the switch module 30, the switch module 30 is switched to cut off the output of the initial current signal. At this time, the first capacitor C1 is discharged to output the discharge current signal to the load 50 through the current output terminal 20 so that the current output terminal 20 can still maintain the current output. This will not cause instability of the output voltage due to the large instantaneous current required by load 50.

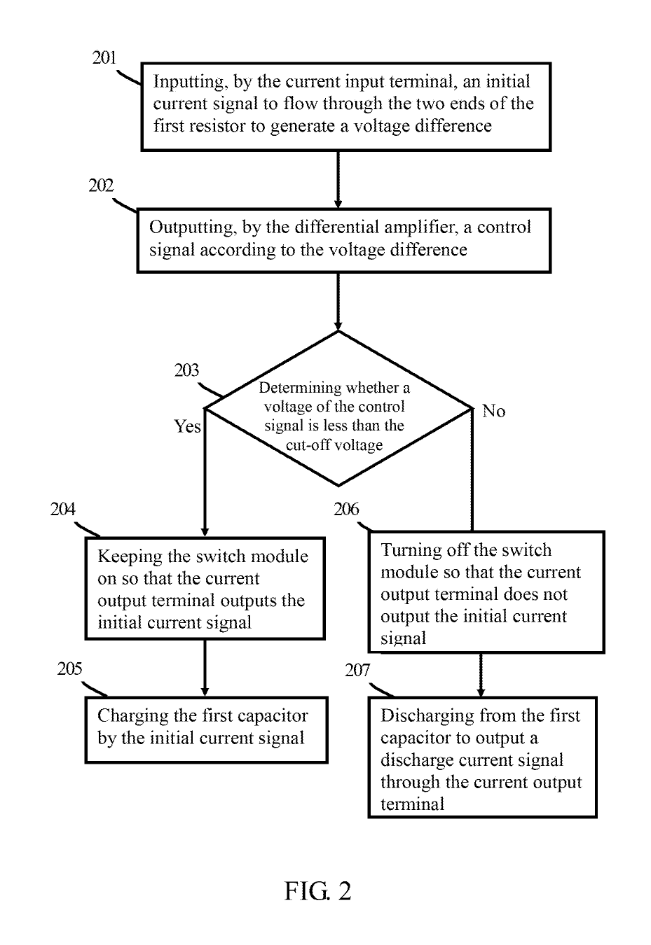

Now please refer to FIG. 2, which is a flowchart showing steps in a method of controlling the current limiting circuit of the present invention. It should be noted here that the method of controlling the current limiting circuit of the present invention is described by taking the current-limiting circuit 1 as an example, but the method is not limited to using the current-limiting circuit 1 described above.

First, the method performs Step 201: inputting, by the current input terminal, an initial current signal to flow through the two ends of the first resistor to generate a voltage difference.

First, when an initial current signal is inputted by the current input terminal 10, it will flow through the two ends of the first resistor R1, and the two ends of the first resistor R1 will have a voltage difference.

Then the method performs Step 202: outputting, by the differential amplifier, a control signal according to the voltage difference.

The positive input end 41 and the negative input end 42 of the differential amplifier 40 are electrically connected to the two ends of the first resistor R1. Thus, the differential amplifier 40 outputs a control signal via the amplified output end 43 according to the voltage difference.

Next, the method performs Step 203: determining whether a voltage of the control signal is less than the cut-off voltage.

When the switch module 30 receives the control signal, it will determine whether the voltage of the control signal is less than the cut-off voltage of the switch module 30.

When the voltage of the control signal is less than the cut-off voltage, the method performs Step 204: Keeping the switch module on so that the current output terminal outputs the initial current signal.

When the load 50 requires a small current, the current value of the initial current signal is smaller, so the voltage of the control signal outputted from the amplified output end 43 is less than the cut-off voltage of the switch module 30, and the switch module 30 is kept on. As a result, the current output terminal 20 will continue to output the initial current signal to the load 50.

Then the method performs Step 205: Charging the first capacitor by the initial current signal.

The initial current signal will synchronously charge the first capacitor C1.

When the voltage of the control signal is greater than the cut-off voltage, the method performs Step 206: The switch module is turned off so that the current output terminal does not output the initial current signal.

When the load 50 requires a large instantaneous current, the current value of the initial current signal increases, so the voltage of the control signal outputted from the amplified output end 43 is greater than the cut-off voltage of the switch module 30. Consequently, the switch module 30 will not continue with the output of the initial current signal.

Finally, the method performs Step 207: Discharging from the first capacitor to output a discharge current signal through the current output terminal.

Finally, the first capacitor C1 is discharged to output the discharge current signal to the load 50 through the current output terminal 20 so that the current output terminal 20 can still maintain the current output.

It should be noted here that the method of controlling the current limiting circuit of the present invention is not limited to the order of the above steps and that the order of the above steps may be changed as long as the objectives of the present invention can be achieved.

With the current-limiting circuit 1, the impact on the output voltage due to the requirement of an instant high current signal by the load 50 can be avoided, and the cost due to the use of large capacitors or inductive components can be reduced.

Although the invention has been described with reference to the above embodiments, it will be apparent to those of ordinary skill in the art that modifications to the described embodiments may be made without departing from the spirit of the invention. Accordingly, the scope of the invention will be defined by the attached claims rather than by the above detailed descriptions.

What is claimed is:

1. A current-limiting circuit, comprising:
a current input terminal;
a current output terminal;
a switch module, comprising a signal input end, a signal output end and a control end, wherein the signal input end is electrically connected to the current input terminal, and the signal output end is electrically connected to the current output terminal;
a differential amplifier, comprising a positive input end, a negative input end and an amplified output end, wherein the positive input end is electrically connected to the signal output end of the switch module, the negative input end is electrically connected to the current output terminal, and the amplified output end is electrically connected to the control end of the switch module;
a first resistor, wherein one end of the first resistor is electrically connected to the signal output end of the switch module and the positive input end, and the opposite end of the first resistor is electrically connected to the negative input end and the current output terminal; and
a first capacitor, wherein one end of the first capacitor is electrically connected between the first resistor and the current output terminal, and the opposite end of the first capacitor is connected to a ground.

2. The current-limiting circuit as claimed in claim 1, wherein the switch module has a cut-off voltage, the current input terminal inputs an initial current signal to flow through the switch module to two ends of the first resistor to form a voltage difference, and the differential amplifier outputs a control signal to the switch module via the amplified output end according to the voltage difference, wherein when the voltage of the control signal is less than the cut-off voltage, the switch module is kept turned on to enable the current output terminal to output the initial current signal and charge the first capacitor, and when the voltage of the control signal is greater than the cut-off voltage, the switch module is turned off and the first capacitor is discharged to output a discharge current signal through the current output terminal.

3. The current-limiting circuit as claimed in claim 1, further comprising a second capacitor, which is connected in parallel with the first resistor.

4. The current-limiting circuit as claimed in claim 1, wherein the positive input end is connected to the first resistor via a second resistor, and the negative input end is connected to the first resistor via a third resistor.

5. The current-limiting circuit as claimed in claim 1, wherein the negative input end is connected to the amplified output end via a fourth resistor, and the positive input end is connected to the ground via a fifth resistor.

6. The current-limiting circuit as claimed in claim 1, wherein the switch module is a metal-oxide-semiconductor field-effect transistor (MOSFET).

7. The current-limiting circuit as claimed in claim 1, wherein the differential amplifier is a rail-to-rail amplifier.

8. The current-limiting circuit as claimed in claim 2, wherein the differential amplifier is a rail-to-rail amplifier.

9. The current-limiting circuit as claimed in claim 3, wherein the differential amplifier is a rail-to-rail amplifier.

10. The current-limiting circuit as claimed in claim 4, wherein the differential amplifier is a rail-to-rail amplifier.

11. The current-limiting circuit as claimed in claim 5, wherein the differential amplifier is a rail-to-rail amplifier.

12. A method of controlling a current limiting circuit, used for a current-limiting circuit, the current-limiting circuit comprising a current input terminal, a current output terminal, a switch module, an differential amplifier, a first resistor and a first capacitor, wherein the switch module has a cut-off voltage, the method comprising the following steps:
inputting, by the current input terminal, an initial current signal to flow through two ends of the first resistor to generate a voltage difference;
outputting, by the differential amplifier, a control signal according to the voltage difference;
determining whether a voltage of the control signal is less than the cut-off voltage;
when the voltage of the control signal is less than the cut-off voltage, the switch module is kept turned on to enable the current output terminal to output the initial current signal;
charging the first capacitor by the initial current signal;
when the voltage of the control signal is greater than the cut-off voltage, the switch module is turned off so that the current output terminal does not output the initial current signal; and
discharging from the first capacitor to output a discharge current signal through the current output terminal.

13. The method of controlling the current limiting circuit as claimed in claim 12, further comprising a step of disposing a second capacitor connected in parallel with the first resistor.

14. The method of controlling the current limiting circuit as claimed in claim 12, further comprising a step of providing a second resistor and a third resistor, wherein the positive input end is connected to the first resistor via the second resistor, and the negative input end is connected to the first resistor via the third resistor.

15. The method of controlling the current limiting circuit as claimed in claim 12, further comprising a step of providing a fourth resistor and a fifth resistor, wherein the negative input end is connected to the amplified output end via the fourth resistor, and the positive input end is connected to the ground via the fifth resistor.
